(19) United States
(12) Patent Application Publication
(10) Pub. No.: US 2015/0072327 A1
(43) Pub. Date: Mar. 12, 2015

(54) WEB SITE FOR USE BY PHYSICIANS FOR TREATING PATIENTS WITH MUSCULOSKELETAL CONDITIONS

(71) Applicant: STRETCHING CHARTS, INC. dba VHI, Tacoma, WA (US)

(72) Inventors: John E. Beaulieu, Lakewood, WA (US); Bryan Heiderscheit, Madison, WI (US); David Cooper, Seattle, WA (US)

(73) Assignee: STRETCHING CHARTS, INC. dba VHI, Tacoma, WA (US)

(21) Appl. No.: 14/468,705

(22) Filed: Aug. 26, 2014

Related U.S. Application Data
(60) Provisional application No. 61/877,047, filed on Sep. 12, 2013.

(51) Int. Cl. G06F 19/00

(52) U.S. Cl. CPC G06F 19/3481
USPC 434/257; 434/247

(57) ABSTRACT

An Internet-based process for use by physicians for treating patients with a musculoskeletal condition. Processes include operating an internet processor for presenting a series of questions to the patient for the patient to answer. The processor determines an evaluation of the patient's level of functioning based on the patient's answers, which includes processing scores from a combination of health ratings and a rating scale for assessment of the patient's musculoskeletal condition. The processor places the patient into a selected one of a plurality of exercise levels responsive to the evaluation and dynamically generates a plurality of exercise routines in response to the evaluation.

### STATEMENT REGARDING FEDERALLY SPONSORED RESEARCH OR DEVELOPMENT

This invention was made with government support awarded by the National Institutes of Health under Grant #1 R43HD065358-01A1 entitled “Increasing Physician Use of Exercise for Treating Osteoarthritis of the Knee.” The government has certain rights in the invention.

### TECHNICAL FIELD

The present invention relates to a web site designed for use by physicians for treating patients with musculoskeletal conditions, and more particularly, the present invention is related to an interactive web site designed for use by physicians for treating patients with osteoarthritis of the knee by providing animated exercises.

### BACKGROUND

As of the time this is being written, over the next 20 years, the incidence of knee osteoarthritis (OA) is projected to increase by 40%. Primary care physicians do not have enough time to deliver all of the preventive and chronic disease services recommended in national practice guidelines, with an estimated 21.5 hours/day needed to do so. This shortage of time combined with the increasing number of patients and decreasing number of primary care physicians, demands that alternative methods of service delivery be explored to meet the standards for quality health care.

The Affordable Care Act will introduce 30-40 million new patients into the system with health care coverage. It is estimated that by 2025 the workloads for family practitioners and internists will increase by 28%. With a growing number of physicians retiring and fewer medical students choosing family practice or internal medicine as their areas of practice, there will be an estimated shortage of approximately 46,000 primary care providers by 2025. As the supply of physicians continues to be stretched thin, patients will confront longer delays for necessary care and potentially receive a lower quality of care. It is clear that innovative strategies for delivering evidence-based quality healthcare are needed to help time-starved physicians provide the best care possible for patients with knee OA.

Physicians are increasingly sending patients to the Internet to learn more about their condition via web sites such as WebMD.com. Unfortunately, currently patients with knee OA receive vague or general advice on therapeutic exercise approximately 75 to 80 percent of the time, lacking the individualization needed to maximize therapeutic effect and adherence.

The present invention provides solutions for the drawbacks inherent in previous approaches by providing a process that simulates exercise prescription as it occurs in rehabilitation medicine. Instead of a one routine fits all approach, effective exercise prescription involves the process of evaluation, prescription, monitoring, re-evaluation and re-prescription. Exercise routines created for patients using the presently disclosed process are assigned based on the patient's level of functioning as a result of intake assessments. A programmed processor places the patient in an exercise level and then dynamically generates an exercise routine for the patient appropriate for the assigned level. The dynamically generated exercise routines are not limited to predetermined banks of routines for each level. Pain and functional levels are constantly monitored, with new exercise routines prescribed to accommodate changes in patient status. This new and novel process also allows patients to request easier or more difficult exercise routines based on a personal assessment of their capabilities. To progress to a more difficult exercise routine, patients are reassessed and must meet specific criteria. Patients who request easier exercise are granted their request. Second, and most important, the process of targeted exercise routine prescription occurs without the continued presence of a healthcare professional. The implications of this paradigm for cost savings are enormous.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides an Internet-based process for use by physicians for treating patients with a musculoskeletal condition. Processes include operating an internet processor for presenting a series of questions to the patient for the patient to answer. The processor determines an evaluation of the patient's level of functioning based on the patient's answers, which includes processing scores from a combination of health ratings and a rating scale for assessment of the patient's musculoskeletal condition. The processor places the patient into a selected one of a plurality of exercise levels responsive to the evaluation and dynamically generates a plurality of exercise routines in response to the evaluation.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 is a system schematic of one example of a dynamic treatment process for patients with a musculoskeletal condition.

FIG. 2 is a process flow diagram of one example of a patient safety monitoring process.

FIG. 3 is a process flow diagram of one example of a patient compliance monitoring process.

FIG. 4 is a process flow diagram of one example of a patient level monitoring process.

FIG. 5 is a process flow diagram of one example of a level placement processor.

FIG. 6 shows an example excerpt of a sign-in welcome page for the Internet web site.

FIG. 7 shows an example excerpt of an enrollment questionnaire web page.

FIG. 8A shows an example excerpt of a web page from the Internet web site, more particularly, a portion of the knee functioning questionnaire.

FIG. 8B shows an example excerpt of a web page from the Internet web site, more particularly, a second portion of the knee functioning questionnaire presented for research purposes.

FIG. 9 shows an example excerpt of a web page from the Internet web site, more particularly, a portion of the health questionnaire.

FIG. 10 shows an example excerpt of a web page from the Internet web site is shown, more particularly, a portion of the exercise and medical questionnaire with a drop down menu feature.

FIG. 11 shows an example excerpt of a web page from the Internet web site, more particularly, a quality of life questionnaire is presented for research purposes.

FIG. 12 shows an example excerpt of a web page including a plurality of avatars.

FIG. 13 shows an example excerpt of a web page showing a number of instructions.

FIG. 14 shows an example of a portion of a web page showing a number of assigned exercises.

FIG. 15 is an example excerpt of a web page showing a questionnaire for recording a patient's workout.

FIG. 16 is an example excerpt of a web page used for changing exercise routines or difficulty level.

FIG. 17 is an example excerpt of a web page demonstrating how to use exercise equipment.

FIG. 18 is an example of a side bar menu appearing on a selected number of web pages.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments for a web site designed for use by physicians for treating patients with a musculoskeletal condition. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to treatment of conditions affecting the knee, however, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or combinations and/or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### DEFINITIONS

Generally, as used herein, the following terms have the following meanings when used within the context of Internet systems:

“Cloud computing” is understood herein to describe a variety of different types of computing concepts that involve a large number of computers that are connected through a real-time communication network (typically the Internet). For example, storage of data in a “cloud” means storage in an Internet server for later retrieval or archival purposes.

As used herein “Internet” is understood to mean an electronic communications network that connects computer networks and organizational computer facilities around the world.

As used herein, “plurality” is understood to mean more than one. For example, a plurality refers to at least two, three, four, five, ten, 25, 50, 75, 100, or more.

As used in this specification, the terms “processor” and “computer processor” encompass a personal computer, a tablet computer, a smart phone, a microcontroller, a microprocessor, a field programmable object array (FPOA), a digital signal processor (DSP), an application-specific integrated circuit (ASIC), a field programmable gate array (FPGA), a programmable logic array (PLA), or any other digital processing engine, device or equivalent capable of executing software code including related memory devices, transmission devices, pointing devices, input/output devices, displays and equivalents.

“Obtaining” is understood herein as manufacturing, purchasing, or otherwise coming into possession of.

“Web site” or “web site,” or simply “site,” is understood herein as a set of related web pages served from a single web domain on the Internet.

### DETAILED DESCRIPTION OF THE FIGURES

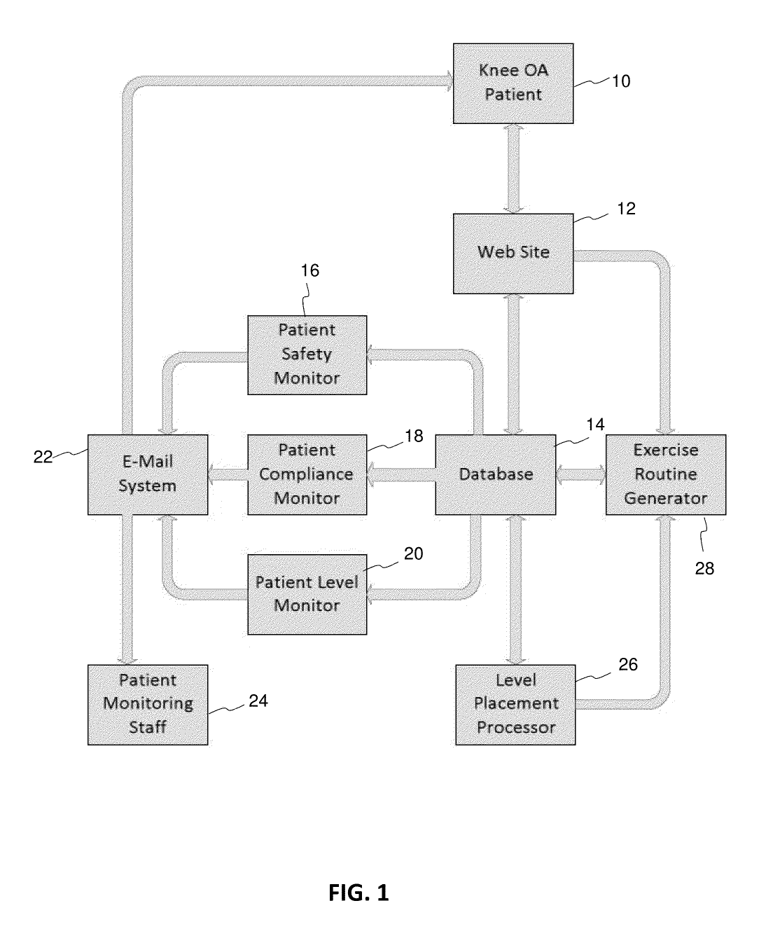

Referring now to FIG. 1, a system schematic diagram of one example of an overall process for use by a physician in treating a patient with a musculoskeletal condition is shown. A patient communicates from a computer 10 with an Internet web site 12. The Internet web site 12 operates to control various processes and to provide the interface with the patient computer 10. The Internet web site 12 operates at an executive level to direct and control a plurality of software programs running on one or more computer processors. The software programs include a patient safety monitoring program 16, a patient compliance monitoring program 18, a patient level monitor 20, an email system 22, a database 14, an exercise routine generator 28, and a level placement processor 26.

In one example embodiment, the Internet web site 12 sends and receives data and control signals to the database 14. The database 14 also transmits data to each of the patient safety monitoring processor 16, the patient compliance monitor 18, and the patient level monitor 20. Each of those programs are in communication with the email system 22. The email system 22, in turn, and sends emails to both the patient computer 10 and patient monitoring staff 24.

In one useful embodiment the database 14 includes data relative to the medical condition of the patient, such as, for example, doctor's notes, patient personal information, patient progress reports, patient monitoring reports, exercise routines assigned to individual patients, and other information deemed useful for treatment of the patient. The data from database 14 is used throughout the system as inputs to the various processes. Similarly, data from various processes may be revised, generated and provided to the database 14 from the Internet web site, the exercise routine generator, the level placement processor 26, and other such as physicians, patients and patient monitoring staff.

In general a higher placement level corresponds to a more difficult and strenuous exercise routine. Therefore, for the purpose of this disclosure a level 1 exercise routine is less strenuous than a level 2 routine. Similarly, a level 2 exercise routine is less strenuous than a level 3 exercise routine. However, the exercise routines are dynamically generated and not limited to a predetermined bank of routines for a given level.

The routine generation processor 28 operates to dynamically generate random exercise routines for a patient in response to level placement. The routine is appropriate for the current Exercise Level assigned to the patient. Each Exercise Level contains a library of exercises from which to randomly choose. Each exercise is marked as being one of three types: Key, Flexibility or Strengthening.

A properly formed exercise routine must follow these rules:

It has a fixed number of exercises, where the number of exercises can vary by level;

It has a minimum and maximum number of Key exercises, variable by level;

It has a minimum and maximum number of Flexibility exercises, variable by level;

It has the rest of the routine filled out by Strengthening exercises; and

Each exercise on the routine is unique. That is, an exercise never appears twice on a routine.

In operation, the routine generation processor 28 starts with the library of exercises for the desired level. It then randomly determines how many Key and Flexibility exercises to put into the routine. The number of each is randomly determined by the minimum and maximums specified for that level. The processor then randomly chooses the desired number of each type of exercise. The rest of the routine is then filled out (up to the fixed maximum number of exercises) using Strengthening exercises.

New routines can be generated for a patient at any time, since a large library of exercises will allow for a large number of random routines. Patients can also elect to replace exercises in the routine from other exercises for their level. As long as the resulting routine follows the above rules, then it's a valid routine. This facilitates altering of routines to patient preferences.

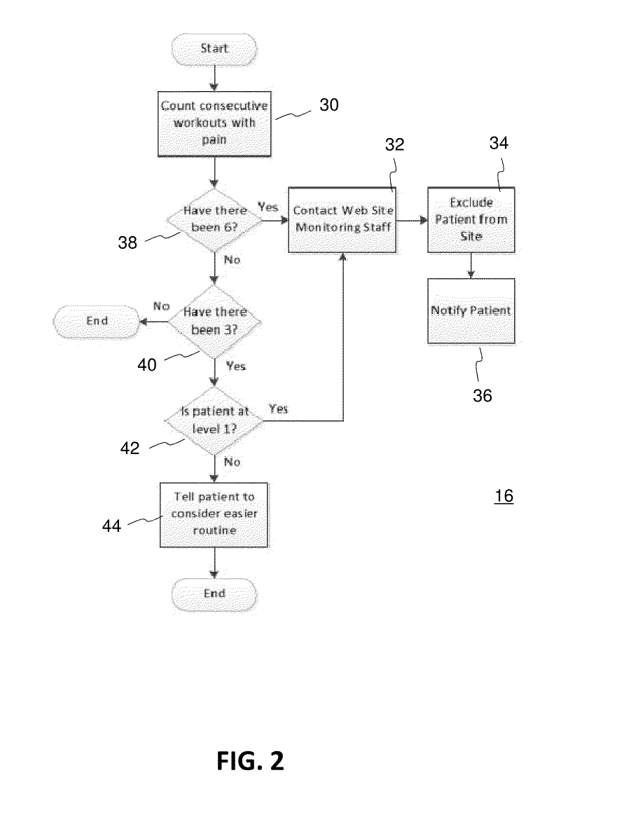

Referring now to FIG. 2, one example of a process flow diagram of a patient safety monitoring process is schematically shown. The patient safety monitoring process 16 is advantageously operated as a software program having a plurality of functional blocks. Using input from the patient the program first operates to count consecutive workouts with pain at block 30. Next a decision block 38 determines whether there have been a specified number of workouts with pain, such as, for example six. If the specified count has been equaled or exceeded the process proceeds to functional block 32 and a report is sent to the web site monitoring staff. From functional block 32 the process proceeds to functional block 34 where the patient is automatically excluded from using the Internet web site. A notification is then sent to the patient by functional block 36 using, for example, the email system 22.

Returning to decision block 38, if the answer to the query is no, the process proceeds to the next decision block 40 which determines whether a second selected number of pain episodes have been experienced. If the number of episodes does not exceed the limit (in this example the limit is three) the safety monitoring process ends and the patient may continue as desired. If the number of episodes does meet or exceed the limit the safety monitoring process continues to decision block 42 where the patient level is tested against level 1. If the patient is at level 1 the process routes to functional block 32 and proceeds as described above. If not, then the process proceeds to functional block 44 and the patient is instructed to consider an easier routine. The monitoring process then ends.

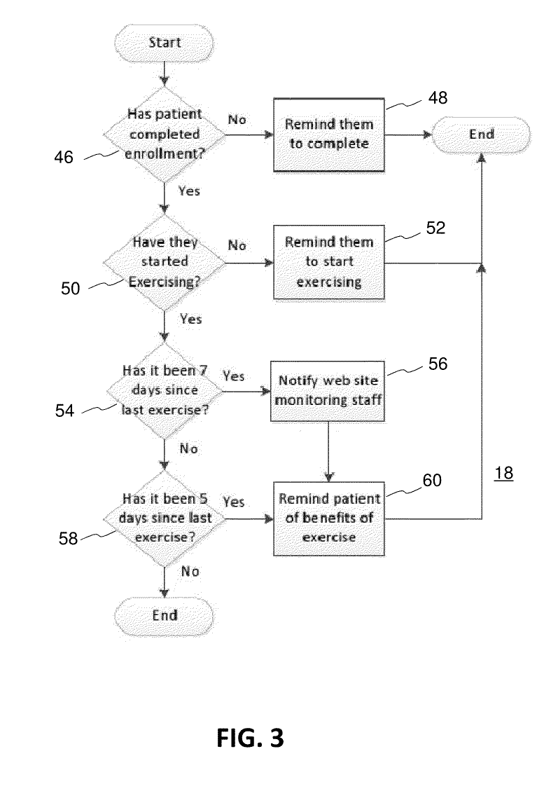

Referring now to, FIG. 3, one example of a process flow diagram of a patient compliance monitoring process is schematically shown. The patient compliance monitoring process 18 begins by determining whether the patient has completed enrollment at decision block 46. If the patient has not completed the enrollment process, an email is sent reminding the patient to complete the enrollment process and the compliance monitoring program ends.

If the patient has completed enrollment the process continues to decision block 50 where the determination is made from the data contained in the database 14 or by direct input, as to whether the patient has started exercising. If the answer is no the process proceeds to functional block 52 where a reminder is displayed, emailed or otherwise transmitted to the patient to remind them to start exercising. At that point the patient compliance monitoring process ends.

If it is determined that the patient has started exercising the process proceeds to decision block 54. At decision block 54 it is determined whether the patient has exercised within the last seven days. If the patient has not exercised within the last seven days the web site monitoring staff is notified by an alert or report sent from functional block 56. After notifying the web site monitoring staff, the process proceeds to functional block 60 where the patient is reminded by a displayed message, email or the like of the benefits of exercise. At that point the patient compliance monitoring process ends.

If it is determined at functional block 54 that it has been less than seven days since the last exercise process proceeds to decision block 58 where it is determined if it has been five days since the last exercise. If it has been at least five days since the last exercise the process is routed to functional block 60 and continues as described above. Otherwise the compliance monitoring process ends and control is returned to the Internet web site executive program. It will be understood by those skilled in the art that the number limits used herein are by way of example only and that the invention is not so limited.

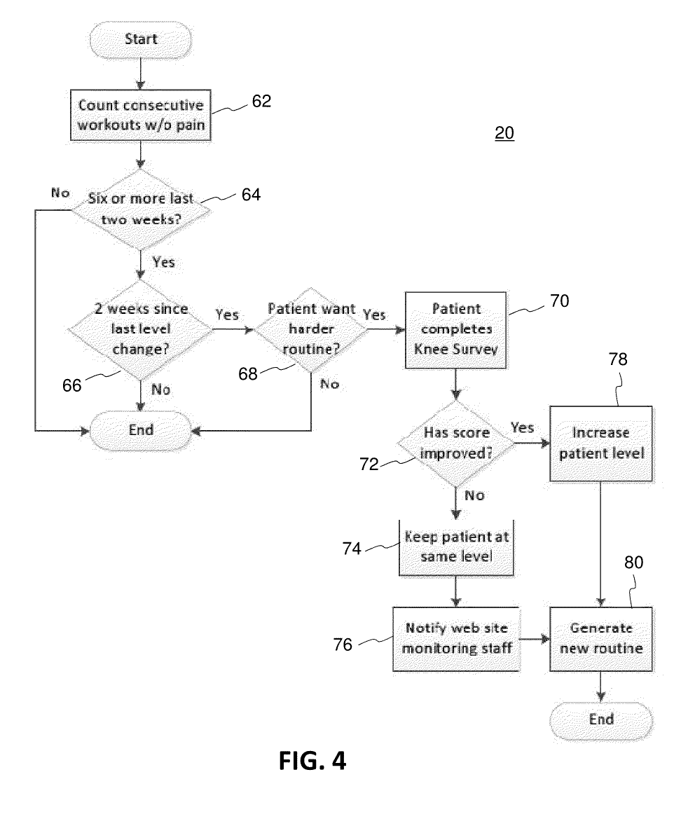

Now referring to FIG. 4, one example of a process flow diagram of a patient level monitoring process is shown. The patient level progression processor 20 starts at functional block 62 by counting consecutive workouts without pain. This information is received from the database 14. Next in decision block 64 a determination is made as to whether six or more consecutive workouts with pain occurred within the last two weeks. If the answer is no, the process ends and the patient is allowed to continue. If the answer is yes decision block 66 determines whether it has been two weeks since the last patient exercise level was changed. If the answer is no a process ends and the patient is allowed to continue with the routine. If the answer is yes the process continues to decision block 68 and an email (or other electronic communication) is sent inquiring whether the patient wants to try a harder routine. If the patient responds in the negative, the process ends as before. If the patient responds positively a knee survey 70 is presented to the patient and the patient must complete the knee survey. At decision block 72 the score from the knee survey is compared with a previous patient score stored in the database. If the score has improved the process proceeds to functional block 78 and the patient level is increased followed by generating a new exercise routine and functional block 80. At that point the process ends. If the score has not improved, functional block 74 determines to keep the patient at the same level and web site monitoring staff is notified automatically through functional block 76. A new routine is still generated at functional block 80 to satisfy the patient's desire for a new routine. The patient level progression process then is completed and the patient may continue with the program.

Scoring of the questionnaires follows known medical scoring or OA index schemes as developed by, for example, the World Health Organization and as available from published medical research. Scoring may be normalized to any convenient scale and adjusted periodically if desired as more data is acquired by the Internet web site or new research becomes available.

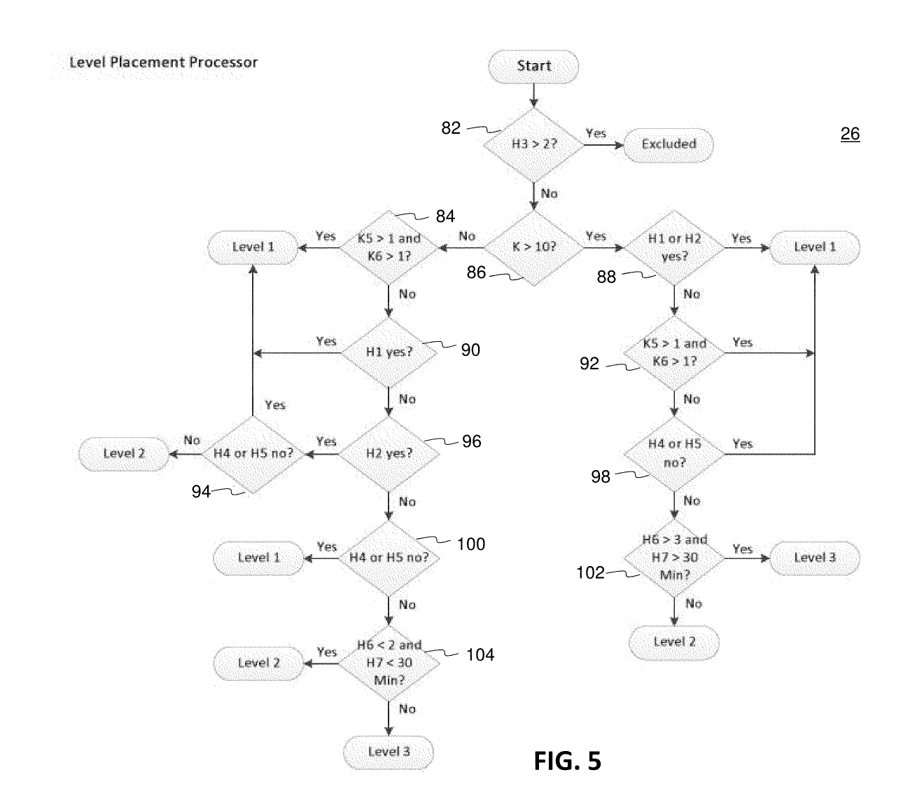

FIG. 5 is one example of a process flow diagram of a level placement processor. The key to the level placement processor is shown in Table 1. In this example, the level placement processor 26 includes a plurality of decision points wherein data is evaluated with respect to health and knee functioning.

TABLE 1
Key to the Level Placement Processor

| | | |
|---|---|---|
| H1 | Health | Do you have swelling that limits your knee |
| | Questionnaire | motion? |
| H2 | Health | Do you use an assistive walking device like a |
| | Questionnaire | cane or walker? |
| H3 | Health | How many times have you fallen in the last |
| | Questionnaire | 6 months? |
| H4 | Health | Can you walk one block without pain and |
| | Questionnaire | shortness of breath? |
| H5 | Health | Do you do any moderately-intense sports, fitness |
| | Questionnaire | or leisure activities that cause small increases |
| | | in breathing or heart rate like golf, dancing |
| | | or walking? |
| H6 | Health | How many times per week do you perform this |
| | Questionnaire | type of activity? |
| H7 | Health | On the days that you exercise, how much time |
| | Questionnaire | do you spend doing moderately-intense |
| | | sports, fitness or recreational activities? |
| K | Knee Functioning | Total score of all questions in the questionnaire. |
| | Questionnaire | |
| K5 | Knee Functioning | Pain at night while in bed. |
| | Questionnaire | |
| K6 | Knee Functioning | Pain sitting or lying. |
| | Questionnaire | |

Still referring to FIG. 5, using the shorthand keyed to Table 1 above the flow diagram will now be described. Starting at decision block 82 if the answer to H3 of the health questionnaire is greater than a preselected score, in this example 2, the patient is excluded from the program. If the answer to H3 does not exceed the preselected score, the process continues to decision block 86 where the total score K is compared to a preselected score limit, in this case 10. If the total score K is not greater than the preselected score limit, the process is routed to decision block 84. If the total score K is greater than the preselected score limit, the process is routed to decision block 88.

Now following the process flow beginning with decision block 84, knee functioning questionnaire questions K5 and K6 are compared against a preselected score, in this example the score is 1. If K5 and K6 are both greater than one the patient is assigned to level 1. If K5 and K6 are not both greater than one, the process proceeds to decision block 90 where the answer for H1 is used to determine the next step. If the answer for health questionnaire question H1 is yes, then level 1 is assigned. If the answer for health questionnaire question H1 is no, the process is routed to decision block 96. If decision block 96 is entered, health questionnaire question H2 is checked for answering in the affirmative. If question H2 was answered yes then the process proceeds to decision block 94. At decision block 94 questions H4 and H5 are used to determine the next step. If the answer to either of the health questionnaire questions H4 or H5 was no then the patient is assigned to level 2. Otherwise the patient is assigned to level 1.

If question H2 was answered no, then the process proceeds to decision block 100. At decision block 100 health questionnaire questions H4 and H5 are compared against a negative response. If the answer to either of the health questionnaire questions H4 or H5 was no patient is assigned to level 1. Otherwise the process proceeds to decision block 104. At decision block 104, health questions H6 and H7 are compared to preselected limits. In this example of question H6 is compared against the number 2, representing the number of times per week moderately intense activities are engaged in by the patient. Question H7 is compared against 30 minutes per day of such activity. If the responses for both questions exceed the comparative limits, the patient is assigned to level 3. If not, the patient is assigned to level 2.

Now following the process beginning with decision block 88, health questionnaire questions H1 and H2 determine whether the patient is assigned to level 1 or may be assigned to a different level. If the answer to question H1 or question H2 is yes the patient is assigned to level 1. Otherwise the process proceeds to decision block 92 where the functioning questionnaire questions K5 and K6 are compared to a preselected score. In this example the preselected score is 1. If both questions are greater than the preselected score, the patient is assigned to level 1. If not the process proceeds to decision block 98 where health questionnaire questions H4 and H5 determine the patient level. If the answer to either question was no, the patient is assigned to exercise level 1. Otherwise the process proceeds to decision block 102 where the health questionnaire questions H6 and H7 are compared to predetermined limits. If the answers to health questionnaire H6 and H7 exceed the predetermined limits, the patient is assigned to exercise level 3, otherwise the patient is assigned to exercise level 2.

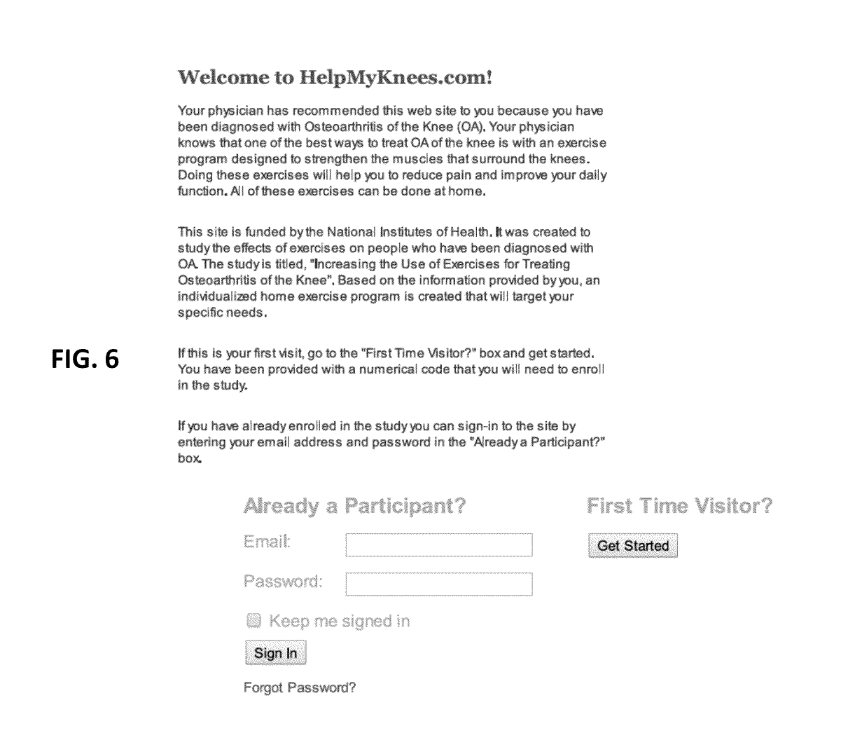

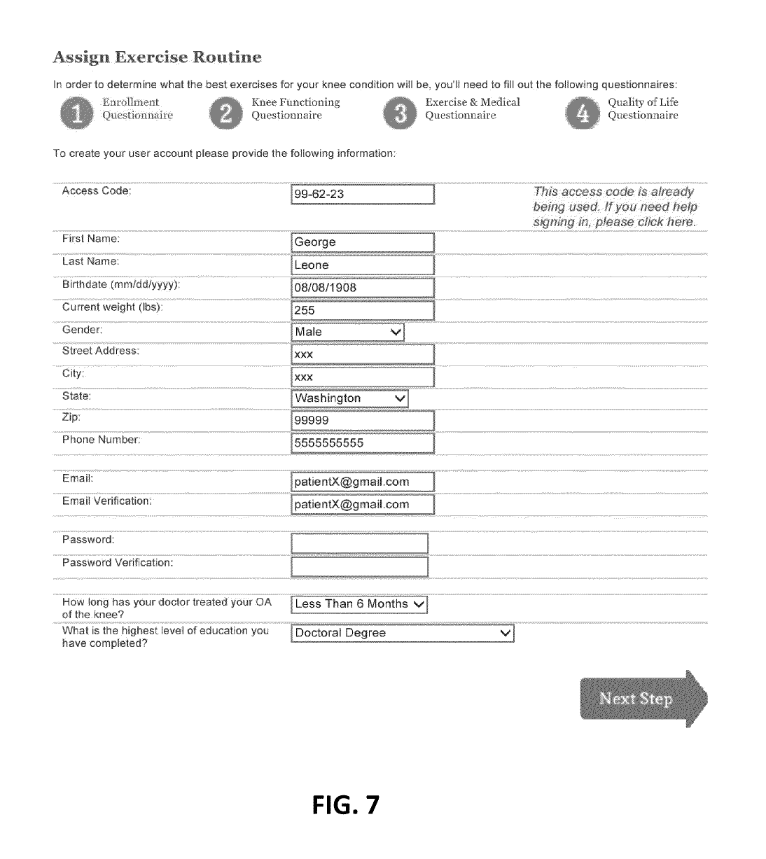

Having described a functional operation elements of the invention above, a working example will now be provided in the form of web pages as presented to a patient when interacting with the Internet web site. Upon entering the web site, the patient will be presented with a welcome page or sign-in page as shown in FIG. 6. If the patient has previously enrolled in the web site the patient may log in using their assigned email address and password. If the patient is entering the web site for the first time they will activate the “Get Started” button. Upon activating the “Get Started” button, a page titled “Assign Exercise Routine” will be displayed as shown in FIG. 7. In this example, the “Assign Exercise Routine” initially presents an enrollment questionnaire including a number of fields to be completed by the patient from their computer. In this case, the access code may be preassigned by the web site administrator in order to control persons having access to the site. Initial patient data includes name, birthdate, weight, gender, address, telephone number, email address and a password assigned by the patient. Some preliminary questions may also be included relative to the patient's health and educational experience. Having completed the initial enrollment questionnaire, the patient may activate the “Next Step” button.

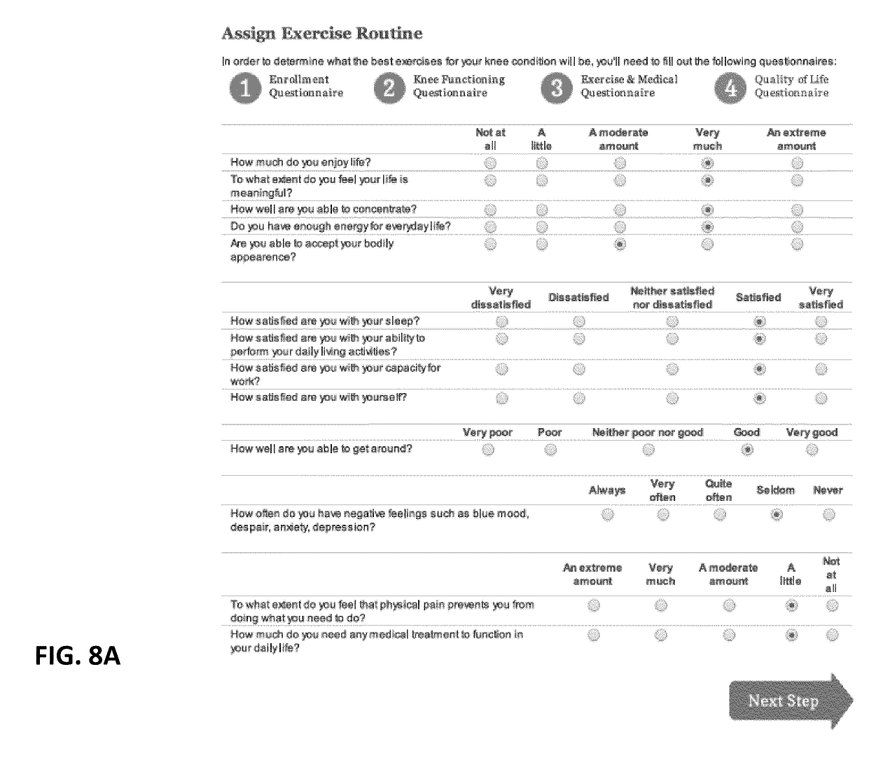

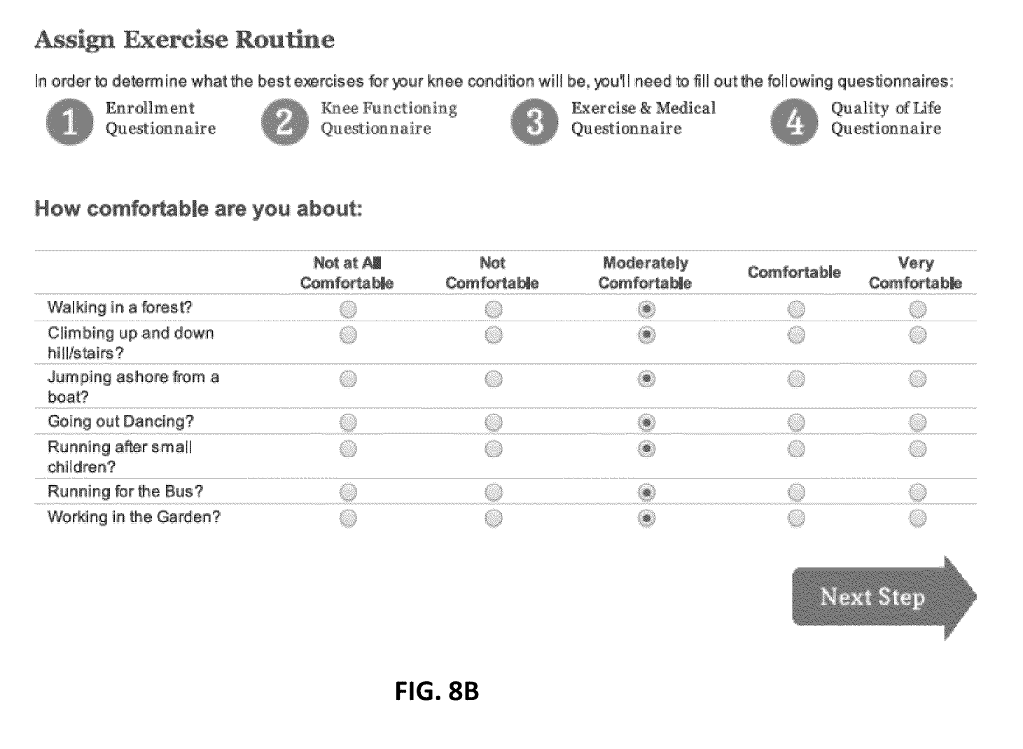

Referring now to FIG. 8A, an example excerpt of a web page from the Internet web site is shown, more particularly, a portion of the knee functioning questionnaire. In this portion of the knee functioning questionnaire the patient is presented with a plurality of survey questions related to knee function. The patient may use a mouse or equivalent computer device to select a response. The responses presented here are “none”, “slight”, “moderate”, “severe”, and “extreme”. Topics for questions may include the following: pain walking on flat surfaces, pain stair climbing, pain at night while in bed, pain sitting or lying, and pain standing upright. A stiffness question may include the following questions, for example, stiffness in the morning and stiffness later in the day. A daily activity question may include questions addressing topics such as, for example, pain ascending stairs, pain rising from sitting, pain walking on flat surfaces, pain getting in/out of a car, and pain sitting.

Referring now to FIG. 8B, an example excerpt of a web page from the Internet web site is shown, more particularly, a second portion of the knee functioning questionnaire is presented for research purposes. In a preferred embodiment, responses to the questions presented here are only used for research data collection and not used for level placement or other purposes. Here the patient is presented with a survey about comfort. The selected responses include “not at all comfortable,” “not comfortable,” “moderately comfortable,” “comfortable,” and “very comfortable.” Questions presented concern, for example, walking in a forest, climbing up and down hill/stairs, jumping ashore from a boat, running after small children, running for the bus and working in the garden. Upon completing the questionnaire as above, the patient activates the “next step” button to proceed to the next webpage.

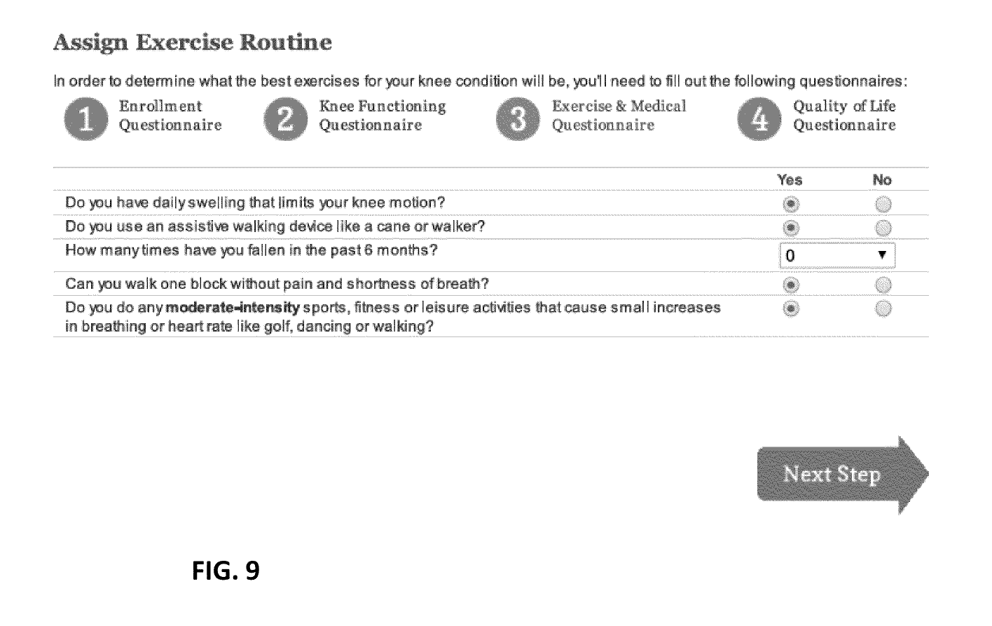

Referring now to FIG. 9, an example excerpt of a web page from the Internet web site is shown, more particularly, a portion of the health questionnaire. On this webpage the patient is presented with a survey related to exercise and medical questions. The questions may include the following and the patient will select a yes or no answer.

Questions include:

Do you have daily swelling that limits your knee motion?

Do you use an assistive walking device like a cane or walker?

How many times have you fallen in the past six months?

Can you walk one block without pain and shortness of breath?

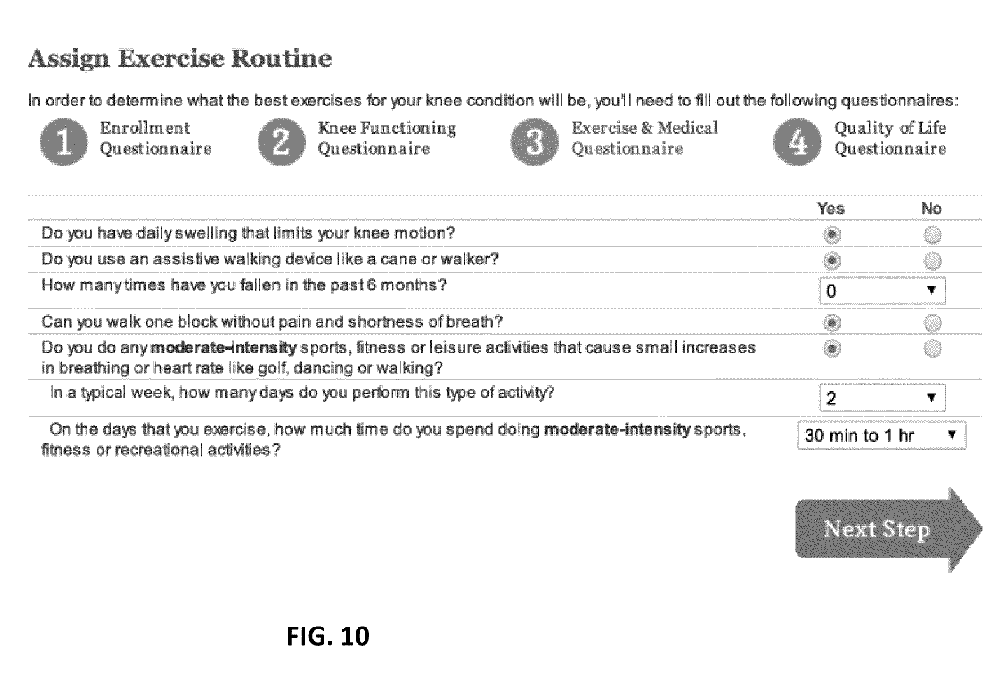

Do you have any moderate-intensity sports, fitness or leisure activities that cause small increases in breathing or heart rate like golf, dancing or walking? (Here, if the answer is yes, a drop down menu appears as shown in FIG. 10 allowing the patient to indicate how many days the type of activity is performed and, secondly, how long the activity is performed).

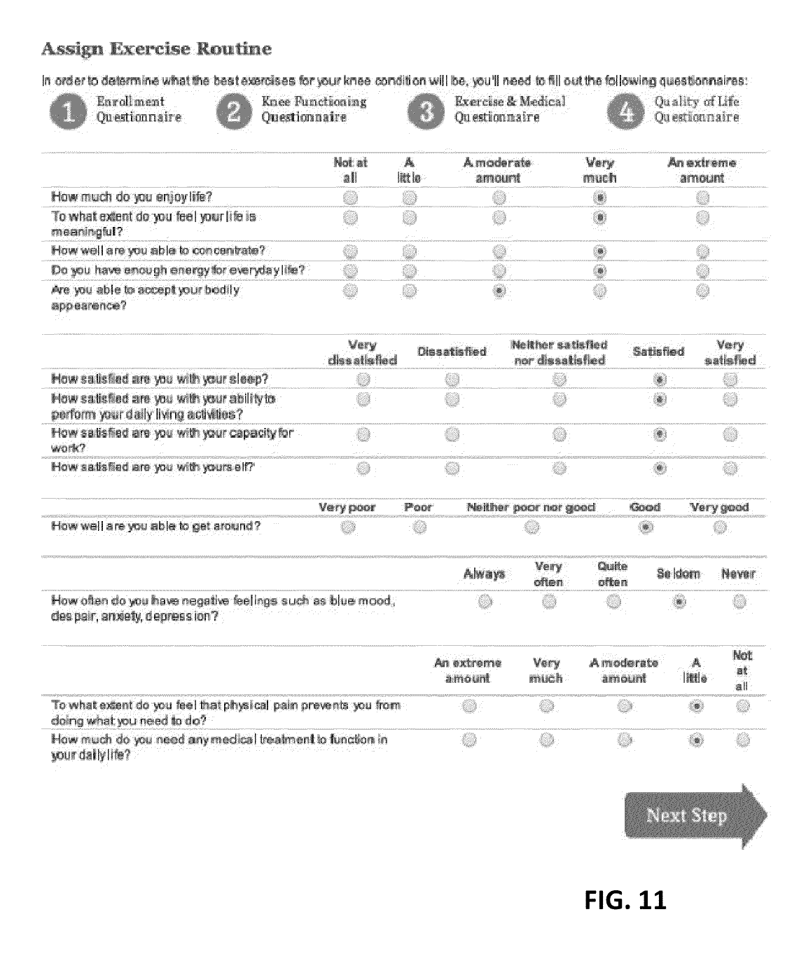

Referring now to FIG. 11, an example excerpt of a web page from the Internet web site is shown, more particularly, a quality of life questionnaire is here presented. In a preferred embodiment the quality of life questionnaire is only used for research data collection and not for level placement or exercise routine generation. In this survey, responses are presented as above ranging from “not at all” to “an extreme amount.” Questions relate to quality of life such as:

How much do you enjoy your life?

To what extent do you feel your life is meaningful?

How well are you able to concentrate?

Similar questions relating to quality of life are included and scored by the processor using scoring methods based on medical research papers, for example. Once the survey portion is completed the patient may activate the “next step” button which will take the patient to the next webpage.

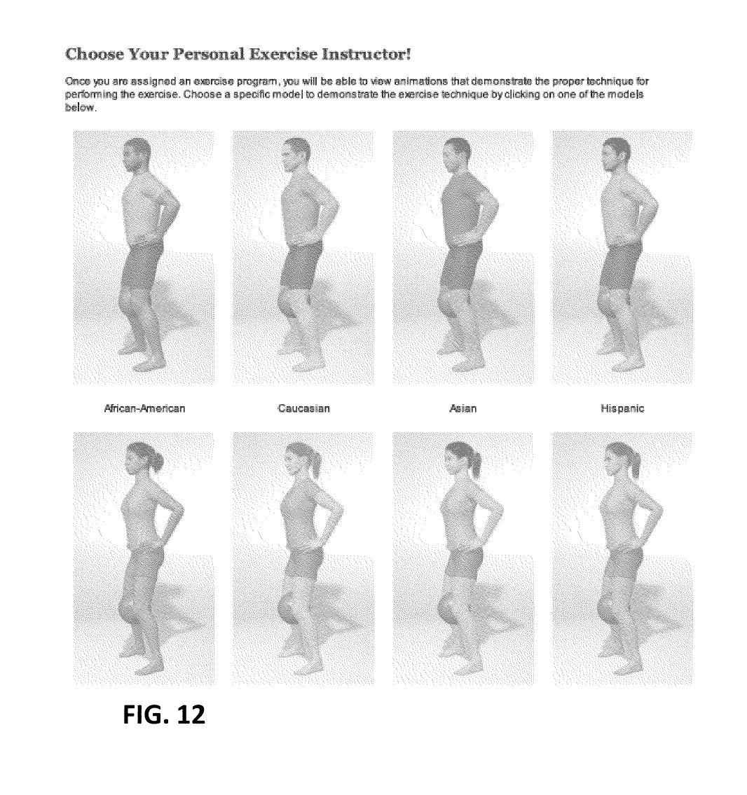

Referring now to FIG. 12, a web page including a plurality of avatars is displayed. Here the patient may choose an avatar to represent the patient in exercise animations that correspond to the exercises assigned to the patient. The patient may select an avatar from a diverse set of avatars by activation with a computer mouse, for example.

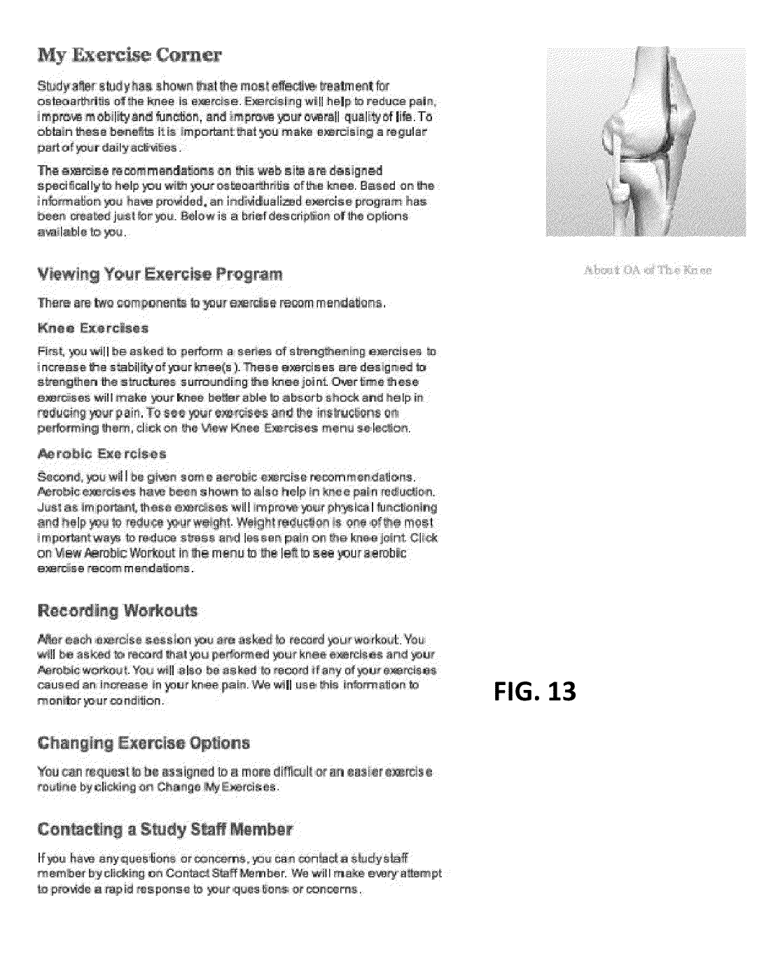

Referring now to FIG. 13, a web page excerpt showing a number of instructions is displayed. The patient may refer to this webpage and other webpages containing information about the exercise program and the treatment program.

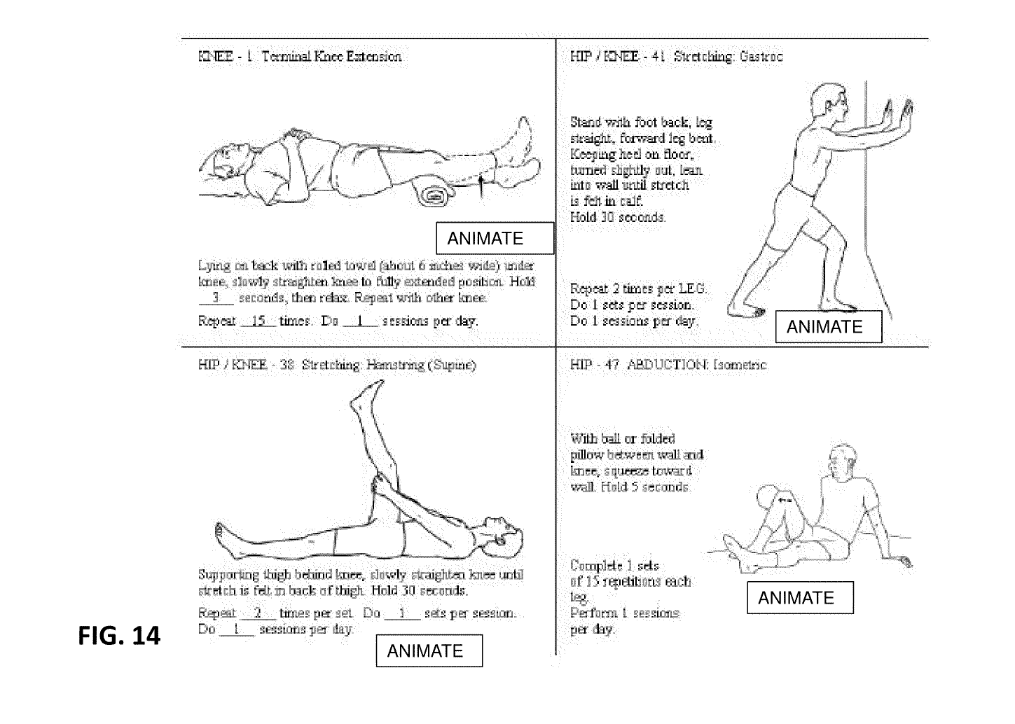

Referring now to FIG. 14, a web page showing a number of assigned exercises is shown. The patient may display an animated demonstration of the exercise using a personal avatar by activating the animation button associated with the chosen exercise. A substantial number of exercises for every level are stored in the database or other convenient memory space for retrieval by the system in response to a query from the Internet processor.

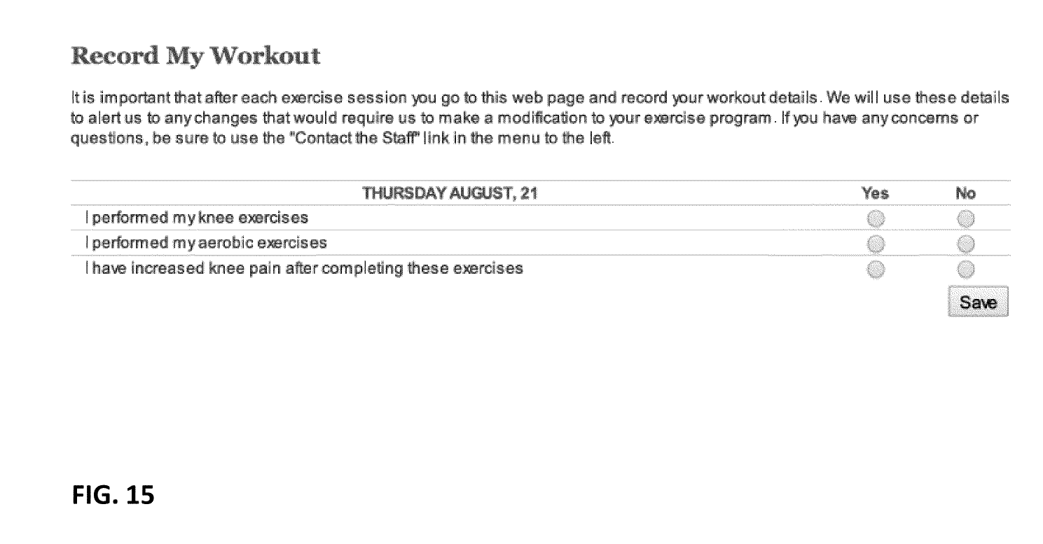

Referring now to FIG. 15, a web page showing a questionnaire for recording a patient's workout is shown. After completing a workout, the patient is required to record the workout using a simple form. Basic questions about performance of knee exercises and aerobic exercises are presented requiring, in this case, a yes or no response. The patient also reports on whether or not knee pain increased after completing the exercises and activates the “save” button when the form is completed. The data is stored in database 14.

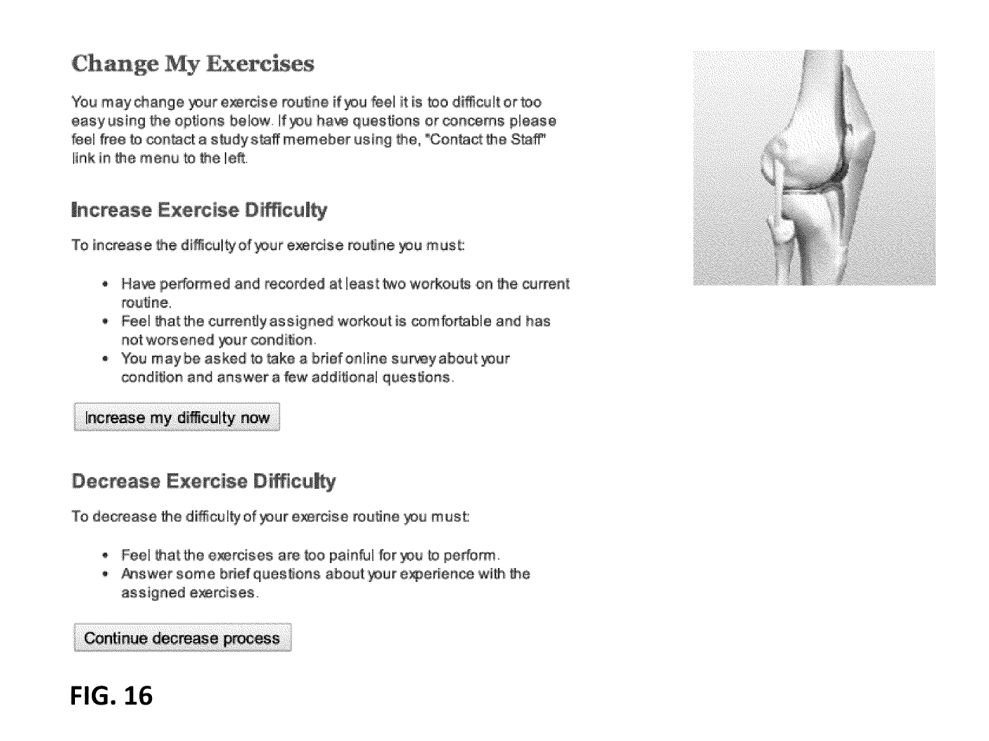

Referring now to FIG. 16, a web page used for changing exercise routine or difficulty level is shown. If a patient wishes to increase or decrease the difficulty level the patient can activate the appropriate button with a computer pointing device. If the patient chooses to increase the difficulty level he is presented with a survey which is scored and runs through the computer process as described above. If the patient chooses to decrease the exercise difficulty a similar form is presented and scored.

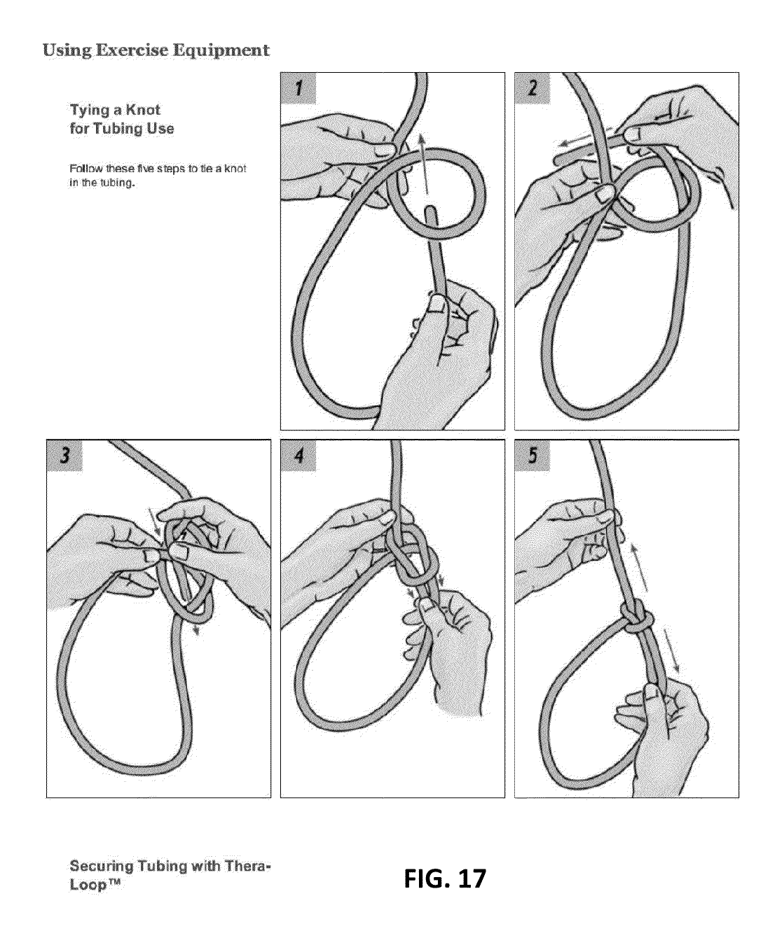

Referring now to FIG. 17, a web page demonstrating how to use exercise equipment is shown. This page in similar pages may be included in the web site to aid the patient's understanding of how to exercise properly and the proper use of deeds and equipment.

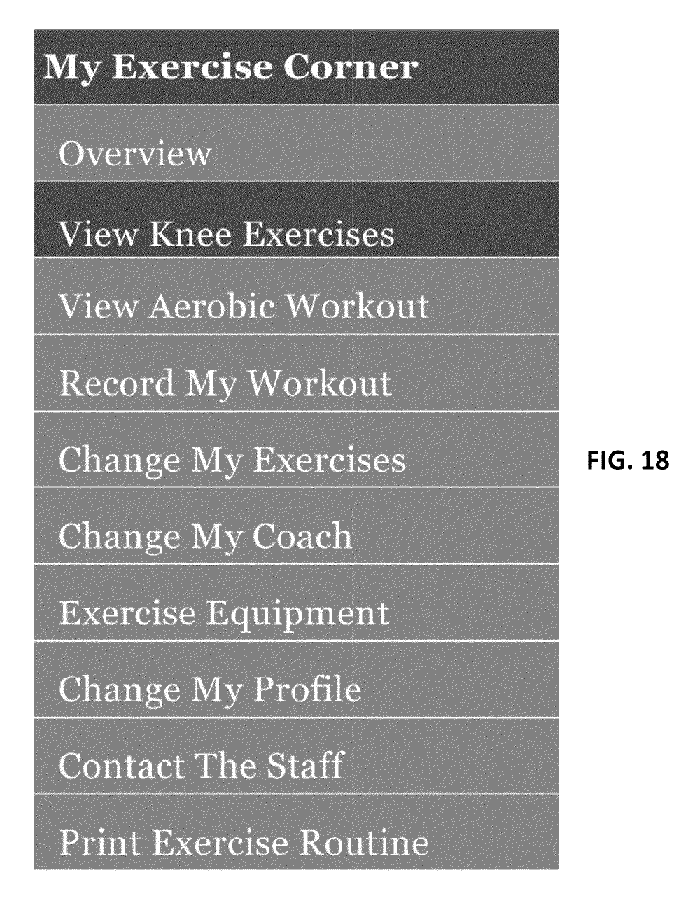

Referring now to FIG. 18, a menu list appearing on a selected number of web pages is shown. The menu list may appear on all or selected web pages as a side bar. The menu list includes items for switching to a desired webpage which may be activated by the patient while on the webpage. Thus a patient may switch from a current webpage to, for example, “change my coach” which will then bring up the avatar selection webpage. In this way a patient can easily use the menu to navigate the web site.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

What is claimed is:

1. An Internet-based process for use by physicians for treating patients with a musculoskeletal condition comprising:
operating an internet processor for presenting a series of questions to the patient for the patient to answer;
operating the processor to determine an evaluation of the patient's level of functioning based on the patient's answers, where operating the processor includes processing scores from a combination of health ratings and a rating scale for assessment of the patient's musculoskeletal condition; and
operating the processor to place the patient into a selected one of a plurality of exercise levels responsive to the evaluation and dynamically generating a plurality of exercise routines in response to the evaluation.

2. The Internet-based process of claim 1 wherein patients are prompted to record their daily workouts and any pain increases as a result of their workout in their daily workout log.

3. The Internet-based process of claim 1 wherein animations using selected avatars demonstrate correctly performed exercises to the patient.

4. The Internet-based process of claim 1 wherein the daily workout log is constantly monitored by the web site and, based on the data on the workout log different notifications are sent to the patient.

5. The Internet-based process of claim 1 wherein processing scores from a combination of health ratings and a rating scale for assessment of the patient's condition further comprises operating a processor to assign a patient exercise level by evaluating a plurality of decision points.

6. The Internet-based process of claim 5 wherein data is evaluated with respect to health and knee functioning.

7. The Internet-based process of claim 6 wherein the patient's condition includes osteoarthritis of the knee.

8. The Internet-based process of claim 1 wherein the patient can request a change in exercise levels or exercise routines.

9. The Internet-based process of claim 1 wherein the Internet process includes a plurality of software programs comprising:
a patient safety monitoring program;
a patient compliance monitoring program;
a patient level monitor;
an email system;
a database;
an exercise routine generator; and
a level placement processor; wherein the plurality of programs are directly or indirectly in communication with and transmit and receive data from the database and internet processor.

10. The Internet-based process of claim 1 wherein the patient receives e-mail messages from the patient compliance monitoring program responsive to a daily workout log.

11. The Internet-based process of claim 9 wherein the database includes medical condition data of the patient, doctor's notes, patient personal information, patient progress reports, patient monitoring reports, exercise routines assigned to individual patients, and other information used for treatment of the patient.

12. The Internet-based process of claim 1 wherein a patient's request to change levels results in the processor assessing whether the level should be changed, and if not, then the processor changes the exercise routines while assigning the patient a current or lower level.

13. The Internet-based process of claim 9 wherein the patient safety monitoring program comprises:
operating a processor to use input from the patient to count consecutive workouts with pain;
determining whether there have been a specified number of workouts with pain;
if the specified count has been equaled or exceeded the process proceeds, a report is generated and the patient is notified as being automatically excluded from using the Internet web site;
if the specified count has not been equaled or exceeded, then determining whether a second selected number of pain episodes have been experienced, and, if the number of episodes does not exceed the limit the safety monitoring process ends.

14. The Internet-based process of claim 9 wherein the patient compliance monitoring process comprises operating a processor to determine whether the patient has completed an enrollment process and if the patient has not completed the enrollment process, a message is displayed on-screen reminding the patient to complete the enrollment process and the compliance monitoring program ends.

15. The Internet-based process of claim 9 wherein the level placement processor comprises a plurality of decision points wherein level placement data is evaluated with respect to health and joint functioning.

16. The Internet-based process of claim 15 wherein the level placement data comprises a combination of patient health survey responses and scoring thereof.

17. An internet-based process for simulating rehabilitation exercise prescription comprising a plurality of exercise routines created for a patient and assigned based on the patient's level of functioning as a result of intake assessments.

18. The process of claim 17 further comprising monitoring pain and functional levels with new exercise routines prescribed to accommodate changes in patient status.

19. The process of claim 18 further comprising allowing patients to request easier or more difficult exercise routines based on a personal assessment of their capabilities wherein patients are reassessed and must meet specific criteria to progress to a more difficult exercise routine.

20. The process of claim 19 wherein patients who request easier exercise are granted their request.

21. The process of claim 1 wherein the processor operates to dynamically generate the plurality of exercise routines according to the following rules:
each exercise has a fixed number of exercises, where the number of exercises can vary by level;
each exercise has a minimum and maximum number of key exercises, variable by level;
each exercise has a minimum and maximum number of flexibility exercises, variable by level;
each exercise has the rest of the routine filled out by strengthening exercises; and
each exercise on the routine is unique.

22. The process of claim 21 wherein the processor starts with the library of exercises for the selected level; it then operates to randomly determine how many key and flexibility exercises to put into the routine wherein the number of each is randomly determined by the minimum and maximums specified for the selected level; the processor then operates to randomly choose a selected number of each type of exercise.
